(19) United States
(12) Patent Application Publication
(10) Pub. No.: US 2008/0212315 A1
(43) Pub. Date: Sep. 4, 2008

(54) Illumination System for Illumination Display Devices, and Display Device Provided with Such an Illumination System

(75) Inventors: Hugo Johan Cornelissen, Eindhoven (NL); Albertus Aemilius Seyno Sluijterman, Eindhoven (NL); Jean Paul Jacobs, Eindhoven (NL); Rolf H. Brzesowsky, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/067,339

(22) PCT Filed: Sep. 18, 2006
(86) PCT No.: PCT/IB2006/053341

§ 371 Date: Mar. 19, 2008

(30) Foreign Application Priority Data
Sep. 19, 2005 (EP) 05108621.3

(51) Int. Cl. F21S 4/00

(52) U.S. Cl. 362/219; 362/223

(57) ABSTRACT

The invention relates to an illumination system for illuminating display devices, comprising at least one light source, and a light guide for guiding light generated by the at least one light source in the direction of a display device. The invention also relates to a display device provided with such an illumination system.

The invention relates to an illumination system for illuminating display devices, comprising at least one light source, and a light guide for guiding light generated by the at least one light source in the direction of a display device. The invention also relates to a display device provided with such an illumination system.

It is known that display devices, such as LCD picture screens, commonly require backlighting of their entire surface area, which backlighting is as homogeneous as possible for rendering a picture visible. A difficulty that often arises, however, in particular in the case of large lighting devices, is that a high luminous intensity cannot be generated with sufficient homogeneity on the entire light emission surface in front of which the picture screen is positioned. This may lead to unpleasant picture effects. Furthermore, these lighting devices should have as small a thickness as possible in many cases. Two main classes of known illumination systems are the side-lit and the direct-lit configuration. In a side-lit configuration, light from a light source is coupled into one or more sides of a light guide where it can be efficiently distributed over the entire display area by total internal reflection. Light is extracted from the light guide in various ways, for instance with a pattern of diffusely scattered dots, or with micro-optical features. In a direct-lit backlight, the light sources are arranged directly behind the display. A uniform illumination of the display area is achieved by spacing the light sources at some distance from the display. It is mandatory to have a light-spreading diffuser in between the light sources and the display. A third class of backlights which has been proposed can be indicated as a channel-lit or indirect-lit configuration, wherein light sources are fully embedded into a light guide, in particular into channels made in said light guide. An advantage of the channel-lit configuration of the illumination system is that a lighting system is provided which is suitable in particular for use as a backlight for large LCD picture screens and which makes available a homogeneous and relatively intensive illumination of the picture screen in combination with a relatively small constructional depth. However, the known channel-lit illumination system also has several drawbacks. A major drawback of such a known illumination system is that the light guide to be applied is relatively thick, and hence heavy, in order to provide sufficient thickness for the channels to receive the light sources.

It is an object of the invention to provide a relatively lightweight and compact illumination system with which a relatively homogeneous and intensive illumination of a display device can be achieved.

The object according to the invention can be achieved by providing an illumination system according to the invention, characterized in that said light source is partially embedded into the light guide. By merely partially embedding the at least one light source into the light-transmissive light guide, the light guide can be made thinner (approximately about 30% thinner compared to a direct-lit illumination system), and hence less heavy. Moreover, by making the light guide thinner, and hence less robust, the illumination system as such can be made relatively compact. An additional advantage of the illumination system according to the invention is that a portion of the at least one light source extends beyond the light guide, thereby allowing improved cooling of the light source.

Preferably, the light guide comprises at least one receiving space for receiving the at least one light source partially. The shape and dimensioning of this receiving space can be of a variable nature, and can for example take the form of a recess (hole) provided in the light guide. The number of light sources to be enclosed partially and simultaneously by the receiving space can also vary and is commonly dependent on the nature of the light source to be applied in the illumination system according to the invention. Since, commonly, one or more elongated fluorescent lamps are used to illuminate a display device, such as an LCD, the receiving space is preferably formed by a channel. To this end, the channel is preferably shaped so as to enclose the light source partially and in a relatively tight manner. In order to optimise the amount of light to be coupled into the light guide, the at least one channel preferably substantially extends along the length of the light guide. In this manner, a relatively efficient coupling of light into the light guide, and hence intensive illumination of the display device, can be achieved. The receiving space is preferably defined by an upper wall and multiple side walls, said side walls being adapted for coupling light generated by the light source into the light guide. For this purpose, the side walls are preferably substantially flat to optimise the relatively unhindered incoupling of light generated by the at least one light source into the light guide. Here, the side walls preferably enclose a substantially right angle with the upper wall. In a particular, preferred embodiment the upper wall is provided with an at least partially light-reflective layer. This layer may be substantially completely reflective. However, under certain circumstances this layer may also be partially translucent for light generated by the light source positioned partially within the receiving space, as a result of which this embodiment of the upper wall is also adapted for coupling of light into the light guide. In a preferred embodiment, the receiving space is situated on the side of the light guide opposite to the side of the light guide facing the display device. In this case the display device can be positioned relatively close to the light guide. However, for a person skilled in the art it is also conceivable to situate the at least one receiving space on the side of the light guide facing the display device to obtain an inverted illumination system.

In practice, the illumination system will commonly comprise multiple light sources, each light source being partially embedded within the light guide. Preferably, multiple separate receiving spaces are provided in the light guide to receive the light sources partially. And each receiving space can be adapted for receiving simultaneously portions of multiple light sources. However, it is also imaginable that each receiving space is adapted to receive a portion of a single light source, as a result of which the number of light sources applied equals the number of receiving spaces applied in the light guide of the illumination system according to the invention.

In a preferred embodiment, each light source is formed by a fluorescent lamp comprising: an at least partially light-transmissive elongated discharge vessel filled with an ionisable substance, and multiple electrodes connected to said vessel, between which electrodes a discharge extends during lamp operation. According to this embodiment, a tubular low-pressure mercury-vapor discharge lamp, for example a cold-cathode fluorescent lamp (CCFL), a hot-cathode fluorescent lamp (HCFL), or an external electrode fluorescent lamp (EEFL), may be employed as a fluorescent lamp in the illumination system. Commonly, a phosphorous coating is applied for allowing low-pressure mercury vapour discharge lamps to convert UV light to visible radiation for illumination of the display device. Although different kinds of fluorescent lamps may be used within the illumination system according to the invention, it is preferable that each fluorescent lamp is formed by a Hot Cathode Fluorescent Lamp (HCFL), since this kind of lamp is ideally suitable for backlighting purposes. The major drawback of HCFL-lamps is that the electrodes of these lamps generate a significant amount of heat during lamp operation, which is detrimental to certain heat-sensitive components of the illumination system, such as optical foils commonly applied onto the light guide. To counteract this major drawback it is considerably advantageous to position a portion of each lamp outside the receiving space and in an open space to allow improved cooling of these electrodes (which may be active (forced) cooling or passive (convection) cooling), and, moreover, to decrease thermal radiation of the lamps towards the heat-sensitive optical foils in a drastic manner. In a preferred embodiment, an inner surface and/or an outer surface of the discharge vessel is provided with an at least partially light-reflective layer. The reflective layer is more preferably provided onto a part of the inner surface and/or outer surface of the discharge vessel. The at least partially light-reflective layer is adapted to direct light generated within the fluorescent lamp towards the light guide. Preferably, a portion of the discharge vessel facing the receiving space, and in particular the side walls defining the receiving space, is left uncovered by the at least partially reflective layer to allow relatively unhindered incoupling of light into the light guide. In case the at least partially reflective layer is positioned outside the discharge vessel, it is conceivable that the layer is positioned substantially at a (small) distance from the lamp.

In an alternative preferred embodiment, the at least one light source is formed by a LED, in particular a side-emitting LED. LEDs are relatively durable and (hence) environment-friendly. Since these LEDs are commonly adapted to generate light having a limited color spectrum, commonly a triplet of LEDs is applied, each triplet consisting of three LEDs adapted for generating red light, green light, and blue light, respectively. In this manner, white light can be generated by each triplet. An advantage of the application of the triplets is that a relatively broad color spectrum can be achieved in this manner. Besides, application of the triplets allows color regulation by switching specific LEDs of the triplet selectively on and off for a specific period, wherein the effective color emitted by the triplet as such can be adapted to the image displayed by the display device to create an improved perception and experience by viewers. Moreover, temporarily switching off specific LEDs will commonly also lead to an overall saving of energy.

The light guide may be formed by a flat plate provided with one or more receiving spaces, wherein the side of the light guide facing a display device is oriented substantially parallel to the opposite side of the light guide. However, in a preferred embodiment the side of the light guide facing a display device is oriented substantially non-parallel with respect to the opposite side of the light guide. In this latter embodiment, the light guide can be shaped so as to be even more compact, which may reduce the overall thickness of the illumination system even further.

In a preferred embodiment, the side of the light guide facing a display device is provided with an extraction structure for extracting light from the light guide in the direction of the display device. The extraction structure may comprise e.g. a diffuse dot pattern, micro-optical structures, volume holograms, surface gratings, cholesteric network polymers, and optically anisotropic micro-structured layers. The optical structures preferably comprise one or more optical foils. In this manner, radiation contained by the light guide can be extracted from the light guide in an optimal manner to illuminate the display device.

The invention also relates to a display device comprising an illumination system according to the invention. Besides Liquid Crystal Displays (LCD) all kinds of displays can be used which require active illumination by an external illumination system according to the invention. However, it must be clear that the illumination system may also be used for other purposes. To this end, the illumination system may for example also be used for direct lighting, or may be applied in light boxes or as part of tanning equipment.

The invention will be further illustrated by way of the following non-limitative embodiments, wherein:

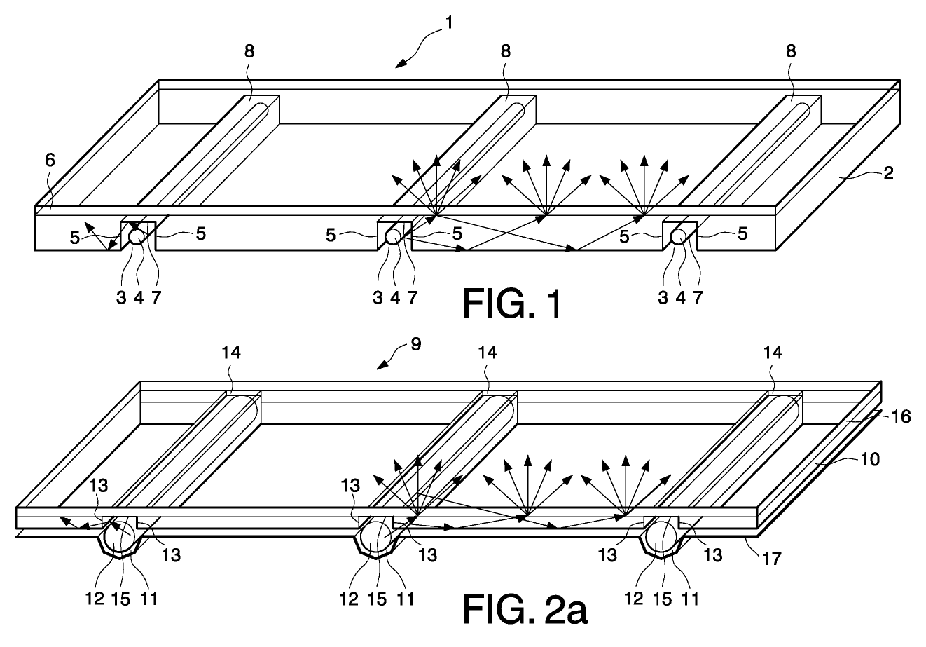

FIG. 1 shows a perspective view of an illumination system known from the prior art,

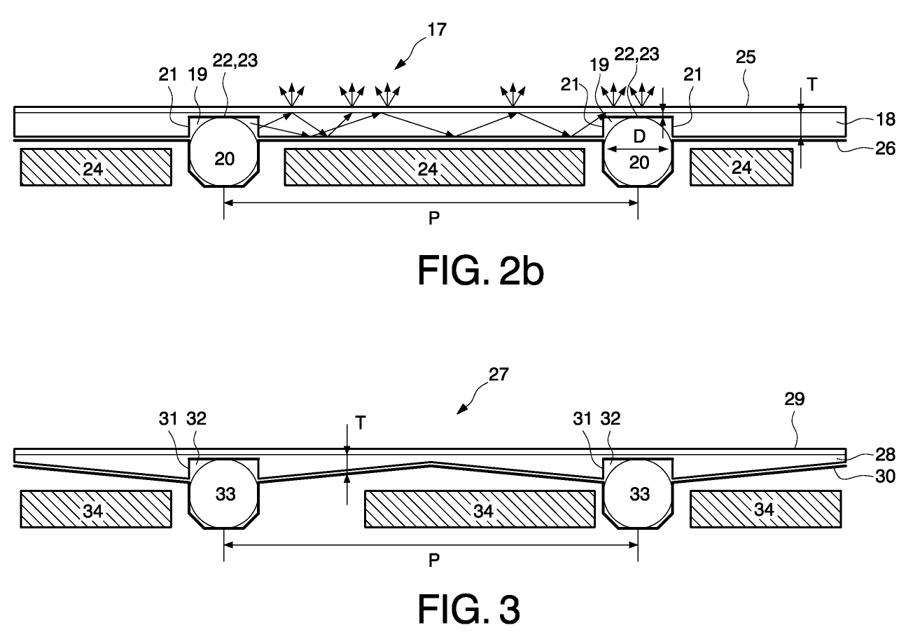

FIG. 2a shows a perspective view of an illumination system according to the invention,

FIG. 2b shows a cross section of the illumination system according to FIG. 2a,

FIG. 3 shows a cross section of an alternative illumination system according to the invention,

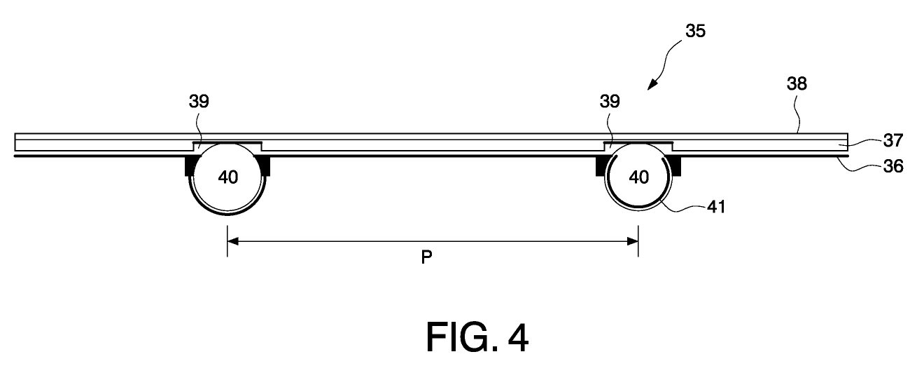

FIG. 4 shows a cross section of a third embodiment of an illumination system according to the invention,

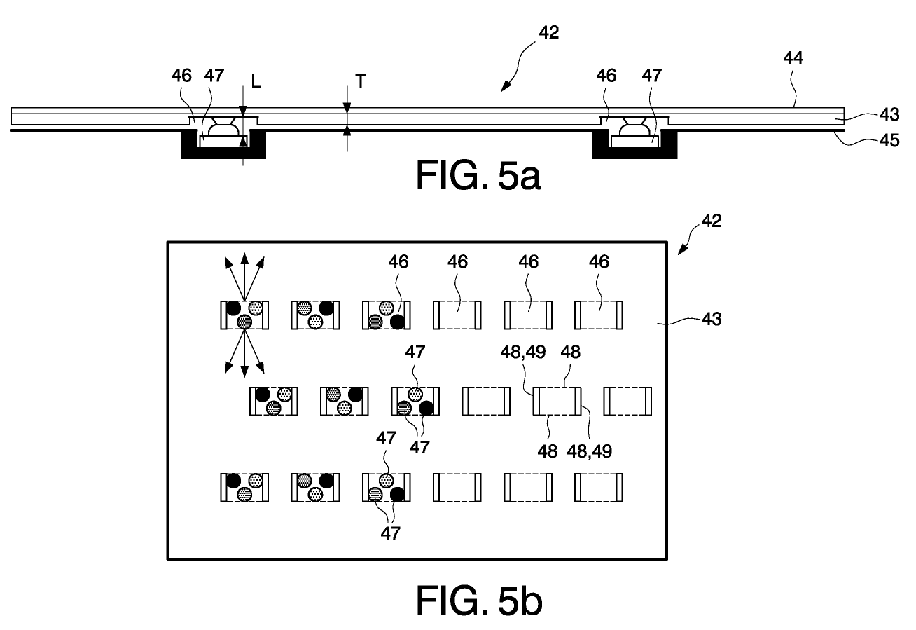

FIG. 5a shows a cross section of a fourth embodiment of an illumination system according to the invention,

FIG. 5b shows a top view of the illumination system according to FIG. 5a,

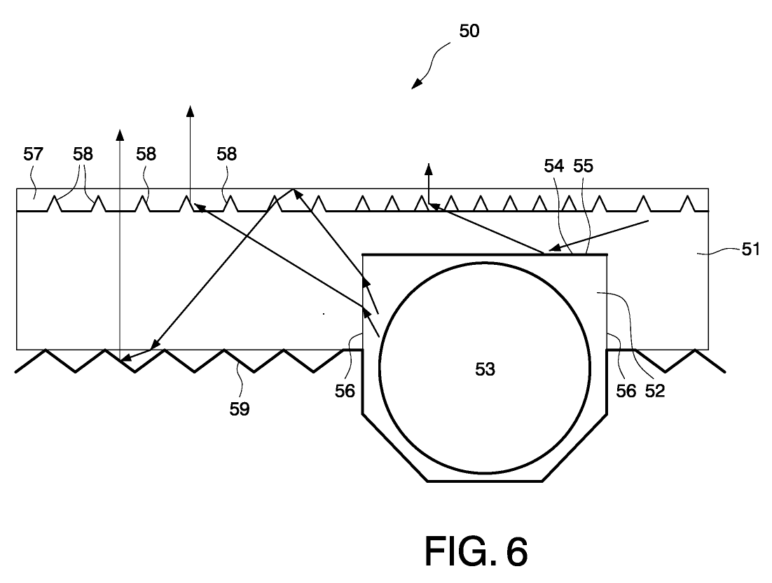

FIG. 6 shows a detailed view of an illumination system according to the invention,

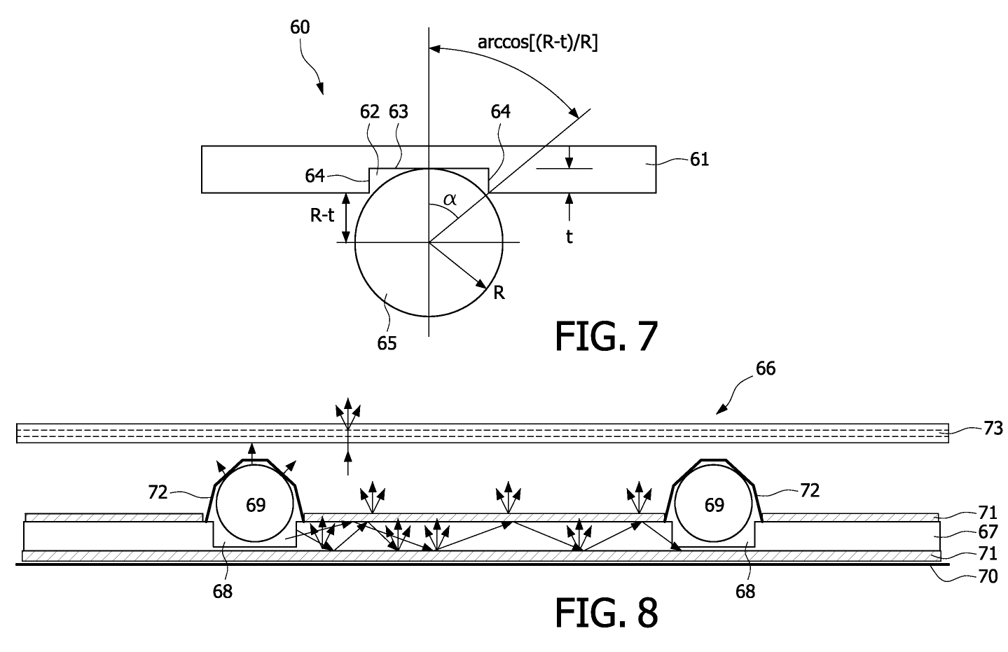

FIG. 7 shows a schematic view of an illumination system according to the invention, and

FIG. 8 shows an alternative embodiment of an illumination system according to the invention.

FIG. 1 shows a perspective view of an illumination system 1 known from the prior art. The illumination system 1 comprises a light guide 2 provided with multiple receiving channels 3 for receiving multiple fluorescent lamps 4, respectively. As shown in this Figure, each lamp 4 is completely embedded into the light guide 2. Via side walls 5 of each channel 3, light generated by a lamp 4 can be coupled into the light guide 2. By means of an extraction structure 6, this light can subsequently be coupled out of the light guide 2 in the direction of a display device, such as an LCD (not shown). An upper wall 7 of each channel 3 is provided with a reflective layer 8 to achieve a substantially homogeneous illumination of the display device. The light guide 2 is commonly made of a light-transmissive polymer, such as polycarbonate or polymethyl methacrylate (PMMA, perspex). The embodiment of the illumination system 1 shown in this Figure is relatively thick and hence heavy. Moreover, cooling of the lamps 4 is relatively difficult due to the complete embedment of the lamps 4 in the respective channels 3.

FIG. 2a shows a perspective view of an illumination system 9 according to the invention. The illumination system 9 comprises a light guide 10 provided with multiple receiving channels 11, each channel 11 being adapted for receiving a fluorescent lamp 12 partially. This partial embedment of the lamps 12 into the light guide 10 results in a thinner and hence substantially less heavy light guide 10. Via opposite side walls 13 of each channel 11, light generated by a lamp 12 can be coupled into the light guide 10. A front wall 14 of each channel 11 is provided with an at least partially light-reflective layer 15 to secure a substantially homogeneous illumination of a display device (not shown). This substantially homogeneous illumination of the display is furthermore determined by means of an extraction structure 16 positioned on top of the light guide 10. Both a bottom side of the light guide 10 opposite to the extraction structure 16, and portions of the lamps 12 extending beyond the receiving channels 11 are covered by a reflective backing 17. This reflective backing 17 is preferably positioned at a small distance from the light guide 10 to prevent disruption of light guidance within the light guide 10. As the light guide 10 has a reduced thickness with respect to the thickness of the light guide 2 shown in FIG. 1, leading to an advantageous weight reduction of the illumination system 9, the height of the side walls 13 of the channels 11 is also reduced, leading to a reduced amount of light being coupledinto the light guide 10. However, it has been shown that a reduction of the thickness of a conventional light guide 2 by even more than 50 percent merely leads to an insignificant and negligible loss of incoupling capacity of the light guide 10. The relation between the height of the side walls 13 and the incoupling capacity is further elucidated in FIG. 7.

FIG. 2b shows a cross section of the illumination system 17 according to FIG. 2a. The illumination system 17 comprises a plate-shaped light guide 18 provided with multiple receiving slots 19 for receiving portions of multiple, elongated discharge lamps 20, respectively. Via side walls 21 of each slot 19, light can be coupled into the light guide 18. An upper wall 22 of each slot 19 is provided with a reflective layer 23. Since the light guide 18 has a limited thickness, leading to partial embedment of the lamps 20, an open space between portions of the lamps 20 extending beyond the slots 19 can be used for accommodating electronic equipment 24, e.g. for controlling the lamps 20, leading to an efficiently designed illumination system 17 with a reduced overall thickness. As can be seen in this Figure, a top surface of the light guide 18 is provided with an extraction structure 25 for controlled outcoupling of light. A bottom surface of the light guide 18 is provided with a reflective backing 26. The top surface and the bottom surface are oriented substantially parallel to one another. In this embodiment, the diameter D of the lamps is 16 mm. The thickness T of the light guide 18 is between 3 and 6 mm, while the thickness of the portion of the light guide 18 between the lamps 20 and the extraction structure 25 is about 1 mm. The mutual distance P between the (centres of the) lamps 20 is 100 mm.

FIG. 3 shows a cross section of an alternative illumination system 27 according to the invention. The illumination system 27 shown in this Figure is constructionally more or less similar to the illumination system 17 shown in FIGS. 2a and 2b, with this difference that a plate-shaped light guide 28 of the illumination system 27 is shaped differently with respect to the light guide 18 shown in detail in FIG. 2b. The presently shown light guide 28 has a flat upper surface to which an extraction structure 29 is applied and has a ridged (tapered) bottom surface covered by a reflective backing 30. This ridged bottom surface is commonly advantageous, since the incoupling capacity, determined by the height of side walls 31 of channels 32 provided in the light guide 28 for receiving portions of multiple lamps 33, can be kept sufficiently large, while other parts of the light guide 28 can be given a further reduced thickness, thereby generating more space for accommodating peripheral equipment 34, such as electronic equipment. Again, the diameter D of the lamps is 16 mm. The thickness T of the light guide 28 is between 3 and 6 mm, dependent on the specific portion of the light guide 28, while the thickness of the portion of the light guide 28 between the lamps 33 and the extraction structure 29 is about 1 mm. The mutual distance P between the (centres of the) lamps 33 is 100 mm.

FIG. 4 shows a cross section of a third embodiment of an illumination system 35 according to the invention. The illumination system 35 comprises a laminate of a reflective backing 36, (at a small distance) a light guide 37, and one or more optical foils 38, wherein the assembly of optical foils 38 forms an extraction structure. The light guide 37 is provided with multiple receiving spaces 39, each space being adapted for receiving a fluorescent lamp 40 partially. To prevent, or at least minimise, loss of light by leading light into a gap present between the backing 36 and the light guide 37, the reflective backing 36 is shaped such that reflection of light into said gap can be counteracted. In the embodiment shown, two lamps 40 are illustrated. The lamp 40 shown on the left is enclosed by the reflective backing 36. However, as regards the lamp 40 shown on the right in this Figure, the reflective backing 36 is interrupted locally in the vicinity of the lamp, since this latter lamp 40 is provided with an internal reflective layer 41 for reflecting light towards the light guide 37. The distance P between the lamps 40 is 80 mm.

FIG. 5a shows a cross section of a fourth embodiment of an illumination system 42 according to the invention. The illumination system 42 comprises a light guide 43 enclosed by an extraction layer 44 and a reflective backing 45. The light guide 43 is provided with multiple receiving recesses 46, each recess 46 being adapted for receiving simultaneously portions of three LEDs 47, of which only a single LED 47 is shown. The LEDs 47 applied are side-emitting LEDs 47, and every triplet of LEDs 47 consists of a first LED 47 being capable of generating red light, a second LED 47 being capable of generating green light, and a third LED 47 being capable of generating blue light. In an alternative embodiment, it is also conceivable to receive, in each recess 46, a single LED adapted to generate white light. Important advantages of the application of LEDs are the relatively long lifespan and hence durability of LEDs, and the capacity to adapt the color to be generated by each triplet of LEDs to the nature of the image visualised by the display device illuminated by the illumination system 42. The thickness T of the light guide is 3 mm in the present embodiment, while the thickness L of the light emitting part of the LED 47 is 3.4 mm.

FIG. 5b shows a top view of the illumination system 42 according to FIG. 5a. In this Figure it is clearly shown that the light guide 43 is provided with multiple recesses 46, with each recess being provided with a triplet of LEDs 47. Each recess 46 is defined by walls 48, in particular four side walls and one upper wall. Both the upper wall and two side walls 48 are provided with a reflective layer 49, as a result of which light can merely be coupled into the light guide 43 via two opposite side walls 48 as shown in FIG. 5. Instead of using multiple small recesses 46, it is also imaginable for a person skilled in the art to apply channels or slots, for example as shown in FIG. 2a, in which an array of LEDs may be arranged. In yet an alternative, more hybrid embodiment of the illumination system according to the invention, different kinds of lamps are applied simultaneously within a single illumination system. For this purpose, it is imaginable to apply both LEDs and fluorescent lamps in the illumination system.

FIG. 6 shows a detailed view of an illumination system 50 according to the invention. The illumination system 50 comprises a light guide 51 provided with multiple slots 52 (of which solely one is shown), each slot 52 being adapted for receiving a portion of a light source 53. Each slot 52 is defined by an upper wall 54 provided with a reflective layer 55, and two opposite and substantially parallel side walls 56. The side walls 56 are suitable for coupling light into the light guide 51. It is noted that it is commonly not required that the side walls 56 are oriented substantially in parallel. It is also conceivable that the side walls 56 are oriented so as to be slightly tapered, with the side walls 56 mutually enclosing an angle. The illumination system 50 further comprises a polarization-selective extraction foil 57 provided with multiple grooves 58. In this Figure, it is shown that the groove spacing above the upper wall 54 is different from the groove spacing of the extraction foil 57 neighbouring this area to secure a substantially homogeneous extraction of light, in particular directional S-polarized light, out of the light guide 51. An opposite side of the light guide 51 is provided with a micro-structured back reflector 59 to optimise reflection of light towards the extraction foil 57. The back reflector 59 fits tightly to the light guide 51 in the vicinity of the lamp 53 to optimise the incoupling efficiency of the illumination system 50.

FIG. 7 shows a schematic view of an illumination system 60 according to the invention. The illumination system 60 comprises a light guide 61 provided with a receiving channel 62 defined by a reflective upper wall 63 and two side walls 64. The system 60 further comprises a lamp 65 positioned partially within the channel 62 and lying against the upper wall 63. The height of the side walls 64 represents the incoupling edge thickness t. The lamp 65 used in this illustrative example is a T5 lamp type with a diameter of 16 mm and hence a radius R of 8 mm. As shown in FIG. 7, aperture α can be calculated by arccosine [(R−t)/t], wherein aperture α is half the total aperture. The aperture can also be expressed as distance, being a representative portion of the circumference of the lamp 65. In the Table below, different usable apertures are given as a function of the incoupling edge thickness t.

| Thickness t of | | |
|---|---|---|
| incoupling light guide | Aperture = arccos | Aperture |
| [mm] | ((8 − t)/8)/180 * 100% | [mm] |
| 1 | 16.1% | 8.1 |
| 2 | 23.0% | 11.6 |
| 3 | 28.5% | 14.3 |
| 4 | 33.3% | 16.8 |
| 5 | 37.8% | 19.0 |
| 6 | 42.0% | 21.1 |
| 7 | 46.8% | 23.5 |
| 8 | 50% | 25.2 |
| 16 (channel-lit) | 100% | 50.3 |

It has been found that a reduction of the incoupling edge thickness t from 16 mm to 6 mm has a limited (negligible) effect on the loss of incoupling efficiency. However, this thickness reduction results in a significant weight-saving of the illumination system 60. For this reason, this thickness is preferably equal to or less than 6 mm.

FIG. 8 shows an alternative embodiment of an inverted illumination system 66 according to the invention for illumination of a display device (not shown). The illumination system 66 comprises a light guide 67 provided with multiple receiving channels 68 for receiving respective fluorescent lamps 69 partially. However, in this particular embodiment the receiving channels 68 are directed towards the display device, as a result of which the lamps 69 are arranged between the display device and the light guide 67. Beneath the light guide 67 a reflective layer 70 is positioned, while a top side of the light guide 67 is provided with a partially reflective and partially translucent layer 71, by means of which layer 71 a polarization-selective extraction may be realised. Optionally, such a polarization-selective extraction layer 71 can be provided at the bottom side as well. The lamps 69 are each covered by a reflective layer 72 which is transmissive for light with specific polarization directions. This particular arrangement makes it easier to apply the reflective layer 72 enclosing each lamp 69. Moreover, in this arrangement it is relatively easy to hide bright light lines, which are normally present close to the lamps 69. In this embodiment, an additional polarization-selective diffuse layer 73 is applied to achieve a relatively intensive and homogeneous illumination of the display device. However, this layer 73 is commonly optional.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The mere fact that certain measures are recited in mutually different dependent claims does not indicate that a combination of these measures cannot be used to advantage.

1. Illumination system for illuminating display devices, comprising:
at least one light source, and
a light guide for guiding light generated by the at least one light source in the direction of a display device,
characterized in that
said light source is partially embedded into the light guide.

2. System according to claim 1, characterized in that the light guide comprises at least one receiving space for receiving the at least one light source partially.

3. System according to claim 2, characterized in that the at least one receiving space is formed by a channel.

4. System according to claim 3, characterized in that the at least one channel substantially extends along the length of the light guide.

5. System according to claim 2, characterized in that the receiving space is defined by an upper wall and multiple side walls, said side walls being adapted for incoupling of light generated by the light source into the light guide.

6. System according to claim 5, characterized in that the upper wall is provided with an at least partially light-reflective layer.

7. System according to claim 2, characterized in that the receiving space is situated on the side of the light guide opposite to the side of the light guide facing the display device.

8. System according to claim 1, characterized in that the illumination system comprises multiple light sources.

9. System according to claim 1, characterized in that each light source is formed by a fluorescent lamp comprising:
an at least partially light-transmissive elongated discharge vessel filled with an ionisable substance, and
multiple electrodes connected to said vessel, between which electrodes a discharge extends during lamp operation.

10. System according to claim 9, characterized in that an inner surface and/or an outer surface of the discharge vessel is provided with an at least partially light-reflective layer.

11. System according to claim 1, characterized in that the at least one light source is formed by a LED, in particular a side-emitting LED.

12. System according to claim 1, characterized in that the side of the light guide facing a display device is oriented substantially parallel to the opposite side of the light guide.

13. System according to claim 1, characterized in that the side of the light guide facing a display device is oriented substantially non-parallel with respect to the opposite side of the light guide.

14. System according to claim 1, characterized in that the side of the light guide facing a display device is provided with at least one optical foil for extracting light from the light guide in the direction of the display device.

15. Display device provided with an illumination system as claimed in claim 1.
